(19) United States
(12) Patent Application Publication
(10) Pub. No.: US 2004/0148156 A1
(43) Pub. Date: Jul. 29, 2004

(54) Word processor systems or the like

(76) Inventor: Paul Hawkins, Winchester (GB)

Correspondence Address: CROWELL & MORING LLP, INTELLECTUAL PROPERTY GROUP, P.O. BOX 14300, WASHINGTON, DC, 20044-4300, US

(21) Appl. No.: 10/468,459

(22) PCT Filed: Aug. 2, 2001
(86) PCT No.: PCT/EP01/09024

(30) Foreign Application Priority Data
Sep. 8, 2000 (GB) 0022023.6

(51) Int. Cl. G06F 17/21

(52) U.S. Cl. 704/10

(57) ABSTRACT

A word processor system or the like capable of displaying textual material, comprising an acronym facilitator tool which facilitates access to a ‘dictionary’ data store of acronyms and their meanings, the said facilitator tool being arranged to provide for acronym identification in textual material displayed, so that a screen tip display is produced consequent upon such identification when the said facilitator tool is in operation, the screen tip display comprising an acronym meaning derived from the ‘dictionary’ data store which corresponds to and which is displayed alongside an acronym thus identified.

This invention relates to word processors systems or the like such as web authoring packages for example, which are capable of displaying to a user/reader, textual material.

In recent times, the technical press seems to have been seized by acronymania to the extent that textual material tends increasingly to include acronyms which are not generally understood, and quite commonly, the meaning of acronyms used (i.e. words, the initial letters of which comprise the acronym) is not immediately apparent to a reader. This may be because the meaning is so obvious to the author of the textual material in which they are included that an explanation is believed to be unnecessary, or alternatively because an explanation is contained elsewhere in the material, perhaps in a glossary, which is not readily available to the reader. Moreover, in some cases, acronyms may have several alternative meanings and even when the meaning is made clear, a definition, which explains the meaning, is not usually given to facilitate a proper understanding of the acronym. For example in a particular passage of text, the ascribed meaning of the acronym ‘IP’ may be ‘Intellectual Property’ and a definition of IP in this case may be ‘Patents, Trade Marks, Registered Designs or Copyright’.

It is an object of this invention to provide in a word processor system or the like capable of displaying textual material, a tool which may be used to facilitate an understanding of the meaning and/or definition of acronyms used in textual material displayed.

According to the present invention a word processor system or the like capable of displaying textual material, comprises an acronym facilitator tool which upon selection facilitates access to a ‘dictionary’ data store of acronyms and their meanings, the said facilitator tool being arranged to provide for acronym identification in textual material displayed, so that a screen tip display is produced consequent upon such identification when the said facilitator tool has been selected, the screen tip display comprising an acronym meaning derived from the ‘dictionary’ data store which corresponds to and which is displayed alongside an acronym thus identified.

The acronym facilitator tool may be arranged to be included in a tool menu or the like, with other word processor tools such as a spell checker for example and to be selected as and when required from the menu.

The acronym facilitator tool may be arranged to operate for acronym identification purposes in accordance with a predetermined algorithm.

The algorithm may serve to identify as acronyms, words in upper case (i.e. capitals letters) which are longer than one character, wherein the final character may be in lower case if there are three or more characters.

The means for selection may comprise a cursor which is moveable about the display under the control of a mouse for selection purposes.

When the acronym facilitator tool is selected, textual material may be scanned progressively for the purpose of acronym identification, stepping from acronym to acronym under control of the mouse, so that the meaning (or possible alternative meanings) of each acronym identified is provided by means of the screen tip display.

The said store may be arranged to include for each acronym a meaning(s) and for each meaning an appropriate definition.

Glossary compilation means may be provided so that the meaning and definition of each acronym identified can be added to a glossary appertaining to the textual material displayed for inclusion therein if required.

When an acronym identified has two or more possible meanings which are identified in the screen tip display, provision for making a choice between the alternatives may be provided so that a user may select an appropriate meaning, for inclusion in the glossary accompanied by an appropriate definition.

It may be arranged that to facilitate glossary compilation, consequent upon acronym selection, a hyper-link is automatically added to the acronym linking it to an appropriate line in the glossary.

One embodiment of the invention will now be described by way of example only with reference to the accompanying drawings in which;

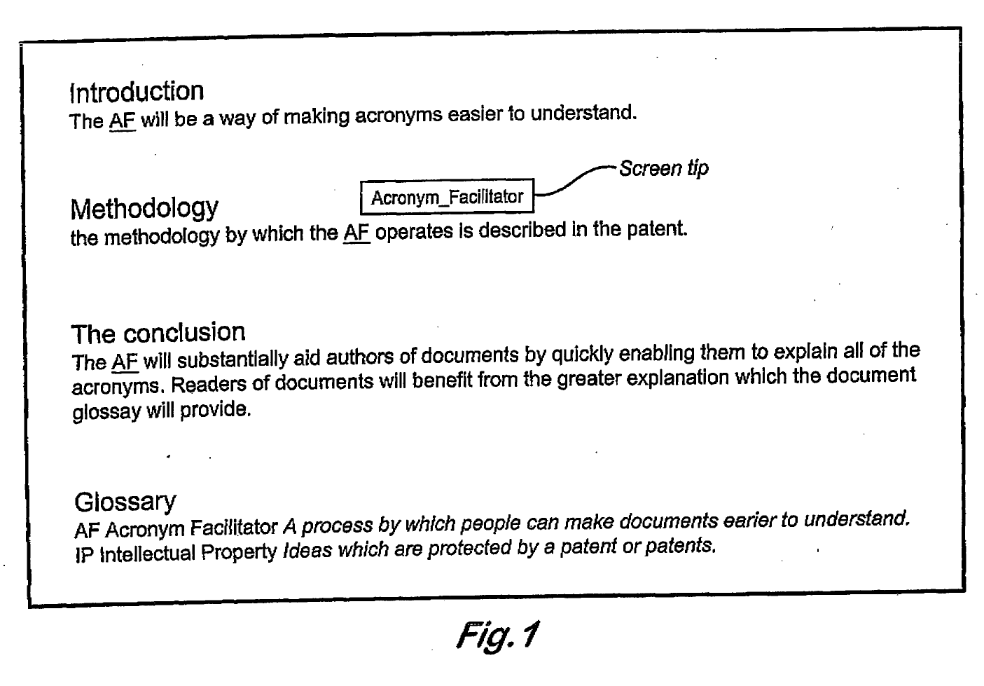

FIG. 1, is word processor screen display showing a screen tip as produced by operation of a word processor acronym facilitator tool;

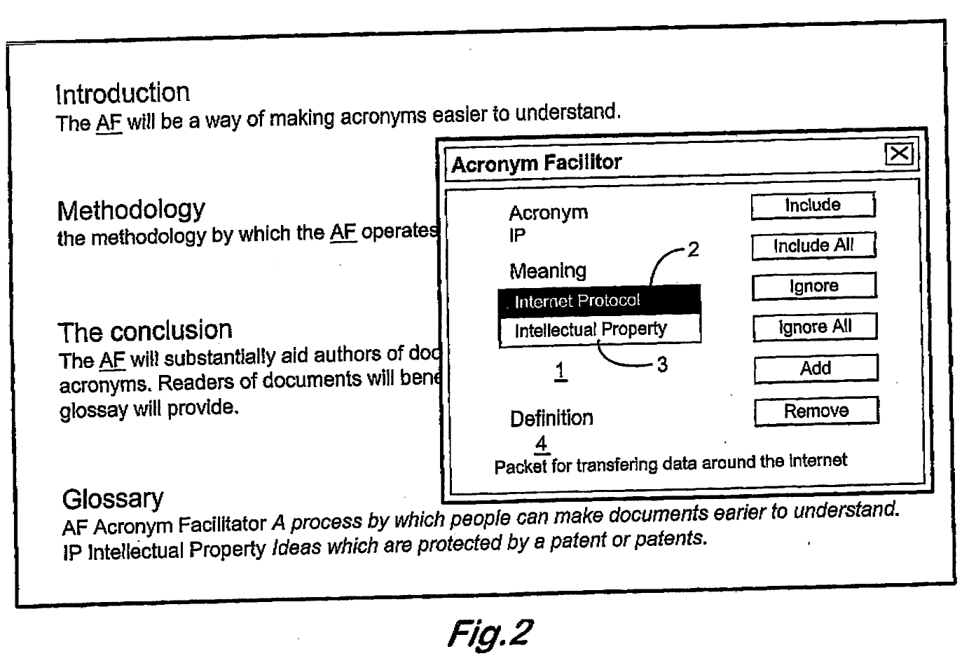

FIG. 2, is word processor screen display showing a dialogue box produced by the word processor acronym facilitator tool, and;

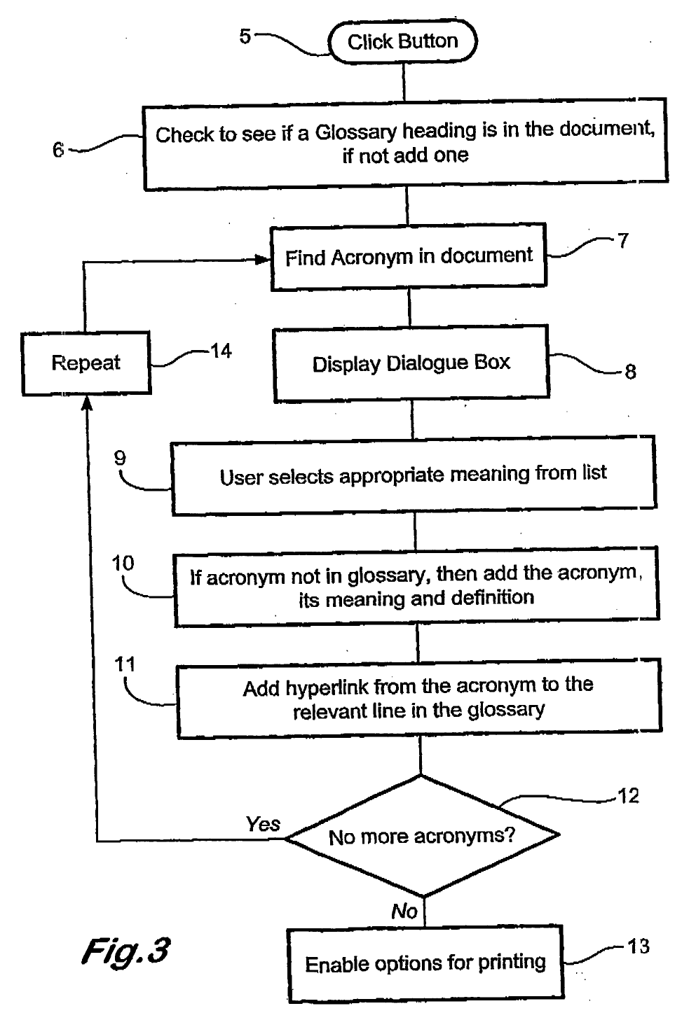

FIG. 3, is a flow diagram showing operational steps performed by the acronym facilitator tool.

In order to provide for an understanding of acronyms, an acronym facilitator tool is included in a word processor and is arranged to be conventionally selectable as required from a tool menu. The facilitator tool includes a dictionary data store of acronyms accompanied by the meaning or meanings of each acronym, and for each meaning an appropriate definition is included, provision being made for the addition of acronyms to the store. It is contemplated that the acronym facilitator could be included as a standard facility in web authoring packages or word processing software so as to make any document displayed easier to read by ensuring that the meaning of acronyms used can be displayed to a user when required.

As shown in FIG. 1, this may be done automatically by adding a screen tip to the acronym so that the meaning is shown when a mouse controlled cursor is placed over an acronym.

Additionally, provision is included for adding an acronym glossary to documents. When the facilitator tool is selected from the tool menu, a document currently displayed by the word processor is searched for acronyms. For this purpose, acronyms are selected in accordance with a predetermined algorithm which defines them as comprising at least two consecutive upper-case letters which may be followed by one lower-case letter. For each acronym found, the acronym dictionary data store is interrogated for corresponding meaning(s) which are displayed to the user so that an appropriate meaning for each can be included in a glossary before proceeding to the next acronym and repeating the procedure. One such display is shown in FIG. 2, which comprises a dialogue box 1, (with textual material in the background) including a glossary which has been compiled by the acronym facilitator. In the dialogue box 1, the acronym ‘IP’ has been selected and two alternative Meaning options 2, and 3, are shown. In this case, Meaning option 2, (Internet Protocol) has been selected and highlighted so that a corresponding Definition 4, of this Meaning option 2, is displayed which is included in the glossary.

As shown in the flow diagram of FIG. 3, the following Steps numbered 5, to 14, are performed for the purpose of constructing an acronym glossary using the functions: Include, Include All, Ignore, Ignore All, Add or Remove, as appropriate, which are as shown on the right hand side of the dialogue box 1, in FIG. 2:

Step 5, click button to select acronym facilitator. The acronym facilitator will be initialised by clicking a button from a tool bar or selecting it from a drop down menu. Alternatively, it could operate in the same way as a spell/grammar checker—whilst the document is being edited;

Step 6, check to see if a glossary heading is included in the document and if not add one. The acronym facilitator adds a glossary to the end of the document. If there is not a section in the document titled “Glossary”, then the title will be added to the document at this stage;

Step 7, find acronym in the document An Acronym is identified as a word longer than 1 character made up of capital letters. A lower case “s” may appear at the end of the word, but this will not be considered as part of the acronym;

Step 8, display dialogue box. The dialogue box is similar to FIG. 2. The user can select which acronym they mean from the choices in the dictionary, or they can use the “Add” and “Remove” buttons to customise their acronym dictionary. If the selected acronym is not appropriate for including in the glossary they may choose the “Ignore” button. The “Include All” and “Ignore All” buttons will apply this choice to all other instances of that acronym found in the text;

Step 9, select an appropriate meaning from those listed or add a new meaning. In instances where a user has more than 1 meaning for the same acronym in their dictionary, the appropriate acronym must be chosen from a list displayed in the dialogue box before they select “Include” or “Include All”.

Step 10, add the acronym its meaning and definition to the glossary if it is not already included. A glossary entry consists of the acronym, the full expansion of that acronym, and an optional definition of that acronym.

Step 11, add hyper-link from the acronym to the relevant line in the glossary. Providing a hyper-link from the acronym to the glossary enables a user to easily interrogate the glossary to determine the meaning of the acronym. A screen tip is also added to the acronym, so the full meaning is shown when the mouse is placed over the acronym. This is shown in FIG. 1;

Step 12, if no more acronyms proceed to;

Step 13, for print options (N.B. Options for printing. A user will not automatically get the benefit of the screen tips when viewing a hard copy of the document. Therefore, a user will be given the option to expand the first or all uses of the acronyms used.) or go to;

Step 14, to repeat for the steps 7 to 11 for the next acronym.

1. A word processor system or the like capable of displaying textual material, comprising an acronym facilitator tool which facilitates access to a ‘dictionary’ data store of acronyms and their meanings, the said facilitator tool being arranged to provide for acronym identification in textual material displayed, so that a screen tip display is produced consequent upon such identification when the said facilitator tool is in operation, the screen tip display comprising an acronym meaning derived from the ‘dictionary’ data store which corresponds to and which is displayed alongside an acronym thus identified.

2. A word processor or the like as claimed in claim 1, wherein the acronym facilitator tool is arranged to be included in a tool menu or the like, and to be selected as required from the menu.

3. A word processor or the like as claimed in claim 1, or claim 2, wherein the acronym facilitator tool is arranged to operate for acronym identification purposes in accordance with a predetermined algorithm.

4. A word processor or the like as claimed in claim 3, wherein the algorithm serves to identify as acronyms, words in upper case (i.e. capitals letters) which are longer than one character, wherein the final character may be in lower case if there are three or more characters.

5. A word processor or the like as claimed in any preceding claim, comprising a cursor which is moveable about the display under the control of a mouse for acronym selection purposes.

6. A word processor or the like as claimed in claim 5, wherein textual material is scanned progressively for the purpose of acronym identification, stepping from acronym to acronym under control of the mouse, so that the meaning (or possible alternative meanings) of each acronym identified is provided by means of the screen tip display.

7. A word processor or the like as claimed in any preceding claim, wherein the said store is arranged to include for each acronym a meaning(s) and for each meaning an appropriate definition.

8. A word processor or the like as claimed in any preceding claim, including glossary compilation means so that the meaning and definition of each acronym identified can be added to a glossary appertaining to the textual material displayed for inclusion therein as required.

9. A word processor or the like as claimed in claim 8, wherein when an acronym identified has two or more possible meanings which are identified in the screen tip display, provision for making a choice between the alternatives is provided so that a user may select an appropriate one of the possible meanings, for inclusion in the glossary accompanied by an appropriate definition.

10. A word processor or the like as claimed in claim 8, or claim 9, wherein it is arranged that in order to facilitate glossary compilation, consequent upon acronym selection, a hyper-link is automatically added to the selected acronym, linking it to an appropriate line in the glossary.

11. A word processor or the like as claimed in claim 1, and substantially as hereinbefore described with reference to the accompanying drawings.
